(19) United States
(12) Patent Application Publication
(10) Pub. No.: US 2021/0062935 A1
(43) Pub. Date: Mar. 4, 2021

(54) SENSING VALVE

(71) Applicant: HAM-LET (ISRAEL - CANADA ) LTD., Nazareth Illit (IL)

(72) Inventors: Ram SABAN, Timrat (IL); Solieman KHOURY, Haifa (IL); David PORAT Agmon, Sharona (IL); Sergey SERYOGIN, Migdal HaEmek (IL)

(21) Appl. No.: 16/960,111

(22) PCT Filed: Jan. 3, 2019
(86) PCT No.: PCT/IL2019/050016

§ 371 Date: Jul. 6, 2020

(30) Foreign Application Priority Data
Jan. 4, 2018 (IL) 256730

(51) Int. Cl. F16K 37/00

(52) U.S. Cl. CPC F16K 37/00

(57) ABSTRACT

A sensing valve comprises: (a) a valve body defining a chamber; (b) a control member configured for controlling a fluid flow through the chamber; (c) inlet and outlet ports; and (d) a sensor arrangement for measuring at least one characteristic of the fluid flow and (e) a microprocessor configured for acquiring and processing data from said sensor arrangements. The microprocessor is preprogrammed for calculating and reporting predetermined characteristics of said incoming and outcoming flows. The sensor arrangement comprises an inlet sensor being in fluid connection with the fluid flow incoming into the inlet port and an inlet sensor arrangement being in fluid connection with the fluid flow incoming into the inlet port.

### FIELD OF THE INVENTION

The present invention releates to valves and, more specifically, to the valves provided with means disposed in or on the valves and indicating, reporting, recording, and/or controlling operation thereof.

### BACKGROUND OF THE INVENTION

According to the common practice, valves are used for controlling a flow of a fluid therethrough. Valves are operated manually or actuated by electrical, pneumatic, or hydraulic means. The valves include at least two ports through which the fluid passes. Fluid enters the valve through a first port, and, when the valve is in the open position, exits the valve through a second port. Fluid does not flow through the valve when the valve is in the closed position. Valves that include more than two ports may redirect the fluid among multiple piping subsystems connected to the ports.

Generally, a valve includes a valve body with at least two ports, a multi-position valve member that controls the flow of fluid through the valve body, and a handle or an actuator that is attached to the valve member via a valve stem. In the open position, the valve conducts fluid flow from one port to the other port, while in the closed position, the valve member received within a valve seat prevents the fluid from flowing from one port to the other port. Because the valve stem is a moving component, packing material, seals, gaskets, or other similar materials or structures known in the art, typically seal the valve stem to prevent fluid from leaking out of the valve.

U.S. Pat. No. 9,822,903 discloses a valve assembly including an actuated valve and a sensor module. The actuated valve includes a body defining a chamber, a first fluid port coupled to the chamber, and a second fluid port coupled to the chamber. The actuated valve further includes a movable stem disposed at least partially within the chamber, the movable stem having a closed position and an open position relative to the chamber, and an actuator coupled to the stem. The sensor module is attached to the actuated valve, and the sensor module includes a microcontroller, and at least one sensor coupled to the microcontroller, the at least one sensor providing a signal associated with a status of the actuated valve.

Acquisition and automatic algorithmic analysis of real-time data reflecting operation of each valve such as pressure, temperature, relative humidity, composition of the fluid and acoustic pattern give an opportunity of monitoring gas or hydraulic systems in terms of a current position (open/closed) and a fault (leakage) in a remote manner. Therefore, there is a long-felt and unmet need for a sensing valve providing data of pressure, temperature, relative humidity, composition of the fluid and acoustic pattern in order to characterize the current status of the valve.

### SUMMARY OF THE INVENTION

It is hence one object of the invention to disclose a sensing valve comprising: (a) a valve body defining a chamber; (b) a control member configured for controlling a fluid flow through the chamber; (c) an inlet port of the valve fluidly connected to the chamber in an upstream manner; (d) an outlet port of the valve fluidly connected to the chamber in an downstream manner; (e) a sensor arrangement configured for measuring at least one characteristic of the fluid flow. The sensor arrangement comprising an inlet sensor arrangement configured for measuring at least one characteristic of the fluid flow incoming into the inlet port and an inlet sensor arrangement configured for measuring at least one characteristic of the fluid flow incoming into the inlet port

It is a core purpose of the invention to provide the sensing valve comprising a microprocessor configured for acquiring and processing data from said sensor arrangements. The microprocessor is preprogrammed for calculating and reporting predetermined characteristics of said incoming and outcoming flows.

Another object of the invention is to disclose the sensing valve comprising a valve body sensor arrangement.

A further object of the invention is to disclose the body sensor arrangement comprising a sensor selected from the group consisting of an accelerometer, a pressure sensor, a temperature sensor, an environmental sensor and any combination thereof.

A further object of the invention is to disclose the inlet sensor arrangement comprising a sensor selected from the group consisting of a pressure sensor, a temperature sensor, a relative humidity sensor, a fluid composition sensor and any combination thereof.

A further object of the invention is to disclose the outlet sensor arrangement comprising a sensor selected from the group consisting of a pressure sensor, a temperature sensor, a relative humidity sensor, a fluid composition sensor and any combination thereof.

A further object of the invention is to disclose the at least one characteristic selected from the group consisting of fluid pressure, fluid temperature, fluid relative humidity and fluid composition.

A further object of the invention is to disclose the inlet and outlet sensor arrangements in fluid connection with inlet and outlet ports, respectively.

A further object of the invention is to disclose the temperature sensor of said valve body sensor arrangement which is in a thermal contact with said valve body.

A further object of the invention is to disclose the microcontroller preprogrammed for recognizing at least one predetermined fault situation and manipulate said control member accordingly.

A further object of the invention is to disclose the microprocessor configured for reporting a characteristic selected from the group consisting of inlet fluid pressure, inlet fluid temperature, inlet fluid humidity, inlet fluid chemical composition, outlet fluid pressure, outlet fluid temperature, outlet fluid humidity, outlet fluid chemical composition, differential pressure, differential temperature, differential humidity, differential chemical composition and any combination therof.

A further object of the invention is to disclose the sensing valve comprising communication means configured for sending the data processed by the microprocessor to a central server, and or cloud based services.

A further object of the invention is to disclose the microprocessor connected to the central server, PLC, and computer or cloud based service providers by a protocol selected from the group consisting of a wired serial communication protocol, a wireless local network, a wireless personal area network, a nearfield communication network, a low power wide area network, a cellular network and any combination thereof.

A further object of the invention is to disclose the sensing valve comprising an actuator configured for controlling a valve position.

A further object of the invention is to disclose the actuator selected from the group consisting of a hydraulic actuator, a pneumatic actuator, an electromagnetic actuator and any combination thereof.

A further object of the invention is to disclose the actuator activated by a command selected from the group consisting of a command generated by a remote controller, a user's manual command, a command generated by the microprocessor on the basis of the processed data and any combination thereof.

A further object of the invention is to disclose the microprocessor preprogrammed for reporting a fault status if the command to change a position of the control member does not result in a change in reported inlet and outlet fluid pressure.

A further object of the invention is to disclose the microprocessor preprogrammed for reporting a cautioning status if the outlet fluid pressure is higher than the inlet fluid pressure.

A further object of the invention is to disclose the microprocessor preprogrammed for transmitting a command selected from the group consisting of opening is forbidden if the outlet fluid pressure is higher than the inlet fluid pressure and opening if the outlet fluid pressure is higher than the inlet fluid pressure only.

A further object of the invention is to disclose the microprocessor preprogrammed for reporting a cautioning status if the fluid pressure, relative humidity, and temperature measure within the inlet and outlet ports are equal.

A further object of the invention is to disclose the microprocessor preprogrammed for transmitting a command selected from the group consisting of opening is forbidden if the fluid pressure, relative humidity, and temperature measure within the inlet and outlet ports are equal and opening if the fluid pressure, relative humidity, and temperature measure within the inlet only.

A further object of the invention is to disclose the microprocessor is configured for generating an electronic document selected from the group consisting of a report file, a statistic file, an alarm file and any combination thereof.

A further object of the invention is to disclose the sensing valve comprising a memory unit configured for storing an electronic document selected from the group consisting of a report file, a statistic file, an alarm file and any combination thereof.

A further object of the invention is to disclose the sensing valve comprising a graphic user interface configured for displaying a current valve status and said report file, statistic file and an alarm files stored in said memory unit.

A further object of the invention is to disclose the accelerometer configured for measuring accelerations applied to the sensing valve.

A further object of the invention is to disclose the microprocessor preprogrammed for analyzing obtained acceleration values and reporting vibrations of the sensing valve.

A further object of the invention is to disclose a method of sensing, reporting and controlling a status of a valve. The aforesaid method comprises steps of: (a) providing a sensing valve further comprising: (i) a valve body defining a chamber; (ii) a control member configured for controlling a fluid flow through the chamber; (iii) an inlet port of the valve fluidly connected to the chamber in an upstream manner; (iv) an outlet port of the valve fluidly connected to the chamber in an downstream manner; (v) a sensor arrangement configured for measuring at least one characteristic of the fluid flow; the sensor arrangement comprises an inlet sensor arrangement configured for measuring at least one characteristic of the fluid flow incoming into the inlet port and an inlet sensor arrangement configured for measuring at least one characteristic of the fluid flow incoming into the inlet port; and a microprocessor configured for acquiring and processing data from said sensor arrangements; the microprocessor is preprogrammed for calculating and reporting predetermined characteristics of said incoming and outcoming flows; (b) providing a central server preprogrammed for acquiring and processing data from the inlet and outlet sensor arrangements; (c) placing the sensing valve into a fluid flow to be controlled; (d) manipulating the control member; (f) measuring the at least one characteristic of the incoming and outcoming fluid flow; (g) processing obtained measurement data; (h) recognizing predetermined statuses of the sensing valve; (i) reporting recognized statuses of the sensing valve.

A further object of the invention is to disclose the step of providing the inlet sensor arrangement comprising providing a sensor selected from the group consisting of a pressure sensor, a temperature sensor, a relative humidity sensor, a fluid composition sensor and any combination thereof.

A further object of the invention is to disclose the step of providing the outlet sensor arrangement comprising providing a sensor selected from the group consisting of a pressure sensor, a temperature sensor, a relative humidity sensor, a fluid composition sensor and any combination thereof.

A further object of the invention is to disclose the step of measuring the at least one characteristic of the incoming and outcoming fluid flow comprising measuring the at least one characteristic selected from the group consisting of fluid pressure, fluid temperature, fluid relative humidity and fluid composition.

A further object of the invention is to disclose the step of measuring the at least one characteristic of the incoming and outcoming fluid flow comprising placing the inlet and outlet sensor arrangements in fluid connection with inlet and outlet ports, respectively.

A further object of the invention is to disclose the method comprising a step of measuring temperature of the valve body by means of placing temperature sensor in a thermal contact with the valve body.

A further object of the invention is to disclose the step of reporting comprising reporting at least one characteristic selected from the group consisting of inlet fluid pressure, inlet fluid temperature, inlet fluid humidity, inlet fluid chemical composition, outlet fluid pressure, outlet fluid temperature, outlet fluid humidity, outlet fluid chemical composition, differential pressure, differential temperature, differential relative humidity.

A further object of the invention is to disclose the method comprising a step of communicating to a central server for sending the data processed by the microprocessor.

A further object of the invention is to disclose method comprising a step of for recognizing at least one predetermined fault situation and manipulate said control member accordingly.

A further object of the invention is to disclose the step of communicating to a central server performed by a protocol selected from the group consisting of a serial communication protocol, a wireless local network, a wireless personal area network, a nearfield communication network, a low power wide area network, a cellular network and any combination thereof.

A further object of the invention is to disclose the step of manipulating the control member comprising changing a position of the control member by means of actuator.

A further object of the invention is to disclose the actuator selected from the group consisting of a hydraulic actuator, a pneumatic actuator, an electromagnetic actuator and any combination thereof.

A further object of the invention is to disclose the step of manipulating the control member comprising activating the actuator by a command selected from the group consisting of a command generated by a remote controller, a user's manual command, a command generated by the microprocessor on the basis of the processed data and any combination thereof.

A further object of the invention is to disclose the step of reporting recognized statuses comprising reporting a fault status if the command to change a position of the control member does not result in a change in reported inlet and outlet fluid pressure.

A further object of the invention is to disclose the step of reporting recognized statuses comprising reporting a cautioning status if the outlet fluid pressure is higher than the inlet fluid pressure.

A further object of the invention is to disclose the method comprising a step of transmitting a command selected from the group consisting of opening is forbidden if the outlet fluid pressure is higher than the inlet fluid pressure and opening if the outlet fluid pressure is higher than the inlet fluid pressure only.

A further object of the invention is to disclose the method comprising a step of reporting a cautioning status if the fluid pressure, relative humidity, and temperature measure within the inlet and outlet ports are equal.

A further object of the invention is to disclose the method comprising a step of transmitting a command selected from the group consisting of opening is forbidden if the fluid pressure, relative humidity, and temperature measure within the inlet and outlet ports are equal and opening if the fluid pressure, relative humidity, and temperature measure within the inlet only.

A further object of the invention is to disclose the method comprising a step of measuring accelerations applied to the sensing valve.

A further object of the invention is to disclose the method comprising a step of analyzing obtained acceleration values and reporting vibrations of the sensing valve.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic view of a mechanical arrangement of a sensing valve;

FIG. 2 is a schematic circuit diagram of a sensing valve; and

FIG. 3 is a schematic view of graphic user interface of a sensing valve.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a sensing valve and a method of sensing, reporting and controlling a status of a valve.

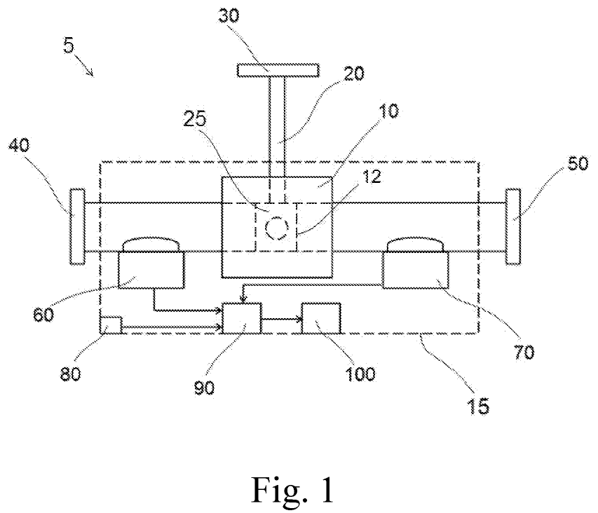

Reference is now made to FIG. 1, presenting a schematic view of a mechanical arrangement of sensing valve 5. The aforesaid valve has inlet port 60 and outlet port 70 fluidly connected to valve chamber 12 accommodating control member 25 floating therewithin and positionable in open and closed positions. Numeral 30 refers to a handle for rotating stem 20 mechanically connected to control member 25. Interpretation of element 30 as an actuator rotating stem 20 is also in the scope of the present invention. A hydraulic actuator, a pneumatic actuator, an electromagnetic actuator and any combination thereof are possible alternative for manually manipulating handle 30.

Sensing valve 5 is provided with 3 sensor arrangements designed for measuring parameters of an incoming fluid flow, outcoming fluid flow and the valve per se. Inlet and outlet sensor arrangements 60 and 70 are in fluid connection with inlet and outlet ports 40 and 50, respectively. Each of arrangements 60 and 70 includes at least one sensor selected from the group consisting of a pressure sensor, a temperature sensor, a relative humidity sensor, a fluid composition sensor. Valve body sensor arrangement 80 is internally disposed within valve body 15 and includes at least one sensor selected from the group consisting of an accelerometer, a temperature sensor, an environmental sensor.

It should be emphasized that control member 25 embodied as a ball floating within a chamber 12 of valve body 10 is disclosed ad exemplum only. Sensor arrangements 60, 70 and 80 are applicable to valves provided with any type of control members.

Sensor arrangements 60, 70 and 80 are electrically coupled to microprocessor 90 which is configured for reporting at least one characteristic selected from the group consisting of inlet fluid pressure, inlet fluid temperature, inlet fluid humidity, inlet fluid chemical composition, outlet fluid pressure, outlet fluid temperature, outlet fluid humidity, outlet fluid chemical composition, differential pressure, differential temperature, differential humidity. The sensing valve 5 is provided with communication means 100 configured for establishing a bidirectional connection with a central server (not shown). Microprocessor 90 can be connected to the central server by a protocol selected from the group consisting of a serial communication protocol (ModBus, Ethernet, USB or Rs485), a wireless local network, a wireless personal area network, a nearfield communication network, a low power wide area network or a cellular network (LTE, WiFi, LoRa, RFID, NFC).

The actuator can be activated by one of alternative commands such as a command generated by a remote controller, an user's manual command, a command generated by said microprocessor on the basis of the processed data.

Microprocessor 90 can be preprogrammed for reporting a fault status if said command to change a position of said control member does not result in a change in reported inlet and outlet fluid pressure. In addition, microprocessor 90 can be preprogrammed for reporting a cautioning status if said outlet fluid pressure is higher than said inlet fluid pressure (back pressure). In order to avoid an accident event, microprocessor 90 can be preprogrammed for transmitting a command such as opening is forbidden if said outlet fluid pressure is higher than said inlet fluid pressure and/or opening if said outlet fluid pressure is higher than said inlet fluid pressure only.

In addition, microprocessor 90 can be preprogrammed for reporting a cautioning status if said fluid pressure, relative humidity, and temperature measure within said inlet and outlet ports are equal. Similar to the back pressure situation, microprocessor 90 can be preprogrammed for transmitting a command such as opening is forbidden if said fluid pressure, relative humidity, and temperature measure within said inlet and outlet ports are equal and/or opening if said fluid pressure, relative humidity, and temperature measure within said inlet only.

As mentioned above, sensing valve 5 is provided with an accelerometer is placed within valve body arrangement 80. The accelerometer is configured for measuring accelerations applied to sensing valve 5. Microprocessor 90 can be preprogrammed for analyzing obtained acceleration values and reporting vibrations of sensing valve 5.

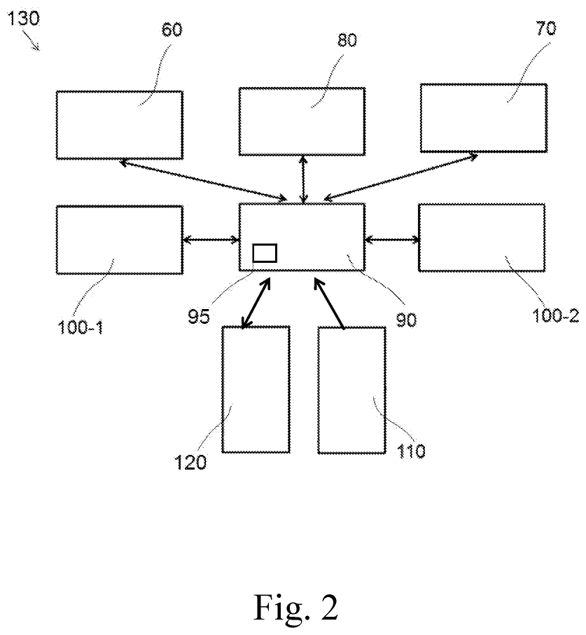

Reference is now made to FIG. 2, presenting a schematic circuit diagram of sensing valve 130. The circuitry is energized by power supply 110. Inlet sensor arrangement 60, outlet sensor arrangement 70 and valve body sensor arrangement 80 are coupled to microprocessor 90 which is configured for acquiring and processing data from sensor arrangements and reporting predetermined events. In addition, microprocessor 90 is configured for generating electronic documents such as a report file, a statistic file, an alarm file which can be stored in memory unit 95. Graphic user interface 120 exemplary embodied on a touch-screen display can provide a user access to the abovementioned electronic documents. Graphic user interface 120 configured for displaying the current status of the valve and the parameters measured aby the sensors embedded in the sensing valve. Communication means 100-1 and 100-2 provide a wired interface and a wireless interface, respectively.

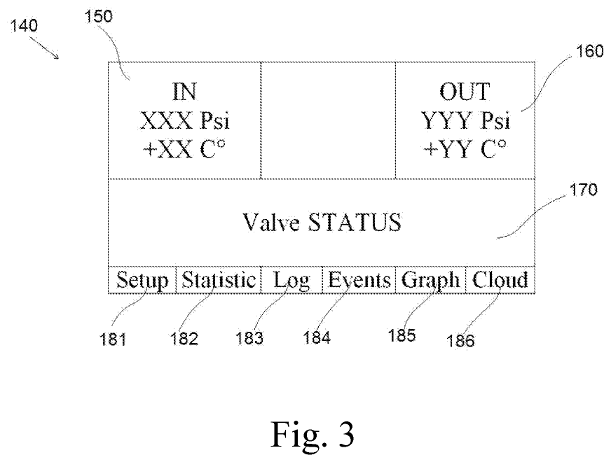

Reference is now made to FIG. 3 presenting exemplary graphic user interface configuration 140. Areas 150 and 160 are designed for displaying parameters of fluid flows incoming into the sensing valve and outcoming from it. The parameters which can be displayed in areas 150 and 160 are of inlet fluid pressure, inlet fluid temperature, inlet fluid humidity, inlet fluid chemical composition, outlet fluid pressure, outlet fluid temperature, outlet fluid humidity, outlet fluid chemical composition, differential pressure, differential temperature, differential humidity and differential chemical composition. Area 170 can display the current status of the sensing valve. The statuses to be displayed can be the following: open valve, closed valve and valve fault. Areas 181 to 186 are designed for an access to maintenance operations (setup, 181) and displaying documents stored in the memory unit such as a statistic report (182), an operation report (183), an alarm/fault report (184), presentation of the abovementioned reports in a graphic manner (185) and access to a remote software server (186).

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

1. A sensing valve comprising:
a. a valve body defining a chamber;
b. a control member configured for controlling a fluid flow through said chamber;
c. an inlet port of said valve fluidly connected to said chamber in an upstream manner;
d. an outlet port of said valve fluidly connected to said chamber in an downstream manner;
e. a sensor arrangement configured for measuring at least one characteristic of said fluid flow;
said sensor arrangement is selected from the group consisting of an inlet sensor arrangement configured for measuring at least one characteristic of said fluid flow incoming into said inlet port and an inlet sensor arrangement configured for measuring at least one characteristic of said fluid flow incoming into said inlet port and combination of said inlet and outlet sensor arrangements;
wherein said sensing valve comprises a microprocessor configured for acquiring and processing data from said sensor arrangements; said microprocessor is preprogrammed for calculating and reporting predetermined characteristics of said incoming and outcoming flows.

2. The sensing valve according to claim 1 comprising a valve body sensor arrangement.

3. The sensing valve according to claim 2, wherein said valve body sensor arrangement comprises a sensor selected from the group consisting of an accelerometer, a pressure sensor, a temperature sensor, an environmental sensor and any combination thereof.

4. The sensing valve according to claim 1, wherein at least one of the following is true:
a. said inlet sensor arrangement comprises a sensor selected from the group consisting of a pressure sensor, a temperature sensor, a relative humidity sensor, a fluid composition sensor and any combination thereof;
b. said outlet sensor arrangement comprises a sensor selected from the group consisting of a pressure sensor, a temperature sensor, a relative humidity sensor, a fluid composition sensor and any combination thereof;
c. said at least one characteristic is selected from the group consisting of fluid pressure, fluid temperature, fluid relative humidity and fluid composition; and
d. said inlet and outlet sensor arrangements are in fluid connection with inlet and outlet ports, respectively.

5. (canceled)

6. (canceled)

7. (canceled)

8. The sensing valve according to claim 3, wherein said temperature sensor of said valve body sensor arrangement is in a thermal contact with said valve body.

9. The sensing valve according to claim 1, wherein at least one of the following is true:
a. said microcontroller is preprogrammed for recognizing at least one predetermined fault situation and manipulate said control member accordingly;
b. said microprocessor is configured for reporting at least one characteristic selected from the group consisting of inlet fluid pressure, inlet fluid temperature, inlet fluid humidity, inlet fluid chemical composition, outlet fluid pressure, outlet fluid temperature, outlet fluid humidity, outlet fluid chemical composition, differential pressure, differential temperature, differential humidity, differential chemical composition and any combination thereof;
c. the sensing valve comprises communication means configured for sending said characteristics to be reported by said microprocessor to a central server; and
d. said microprocessor is connected to said central server by a protocol selected from the group consisting of a serial communication protocol, a wireless local network, a wireless personal area network, a nearfield communication network, a low power wide area network, a cellular network and any combination thereof.

10. (canceled)

11. (canceled)

12. (canceled)

13. The sensing valve according to claim 1 comprising an actuator configured for controlling a valve position.

14. The sensing valve according to claim 7, wherein said actuator is selected from the group consisting of a hydraulic actuator, a pneumatic actuator, an electromagnetic actuator and any combination thereof.

15. The sensing valve according to claim 7, wherein said actuator is activated by a command selected from the group consisting of a command generated by a remote controller, an user's manual command, a command generated by said microprocessor on the basis of said processed data and any combination thereof.

16. The sensing valve according to claim 1, wherein said microprocessor is preprogrammed for reporting a fault status if said command to change a position of said control member does not result in a change in reported inlet and outlet fluid pressure.

17. The sensing valve according to claim 1, wherein said microprocessor is preprogrammed for reporting a cautioning status if said outlet fluid pressure is higher than said inlet fluid pressure.

18. The sensing valve according to claim 11, wherein said microprocessor is preprogrammed for transmitting a command selected from the group consisting of opening is forbidden if said outlet fluid pressure is higher than said inlet fluid pressure and opening if said outlet fluid pressure is higher than said inlet fluid pressure only.

19. The sensing valve according to claim 11, wherein said microprocessor is preprogrammed for reporting a cautioning status if said fluid pressure, relative humidity, and temperature measure within said inlet and outlet ports are equal.

20. The sensing valve according to claim 11, wherein said microprocessor is preprogrammed for transmitting a command selected from the group consisting of opening is forbidden if said fluid pressure, relative humidity, and temperature measure within said inlet and outlet ports are equal and opening if said fluid pressure, relative humidity, and temperature measure within said inlet only.

21. The sensing valve according to claim 11, wherein said microprocessor is preprogrammed for controlling at least one additional valve.

22. The sensing valve according to claim 3, wherein said accelerometer is configured for measuring accelerations applied to said sensing valve.

23. The sensing valve according to claim 16, wherein said microprocessor is preprogrammed for analyzing obtained acceleration values and reporting vibrations of said sensing valve.

24. The sensing valve according to claim 1, wherein said microprocessor is configured for generating an electronic document selected from the group consisting of a report file, a statistic file, an alarm file and any combination thereof.

25. The sensing valve according to claim 1 comprising a memory unit configured for storing an electronic document selected from the group consisting of a report file, a statistic file, an alarm file and any combination thereof.

26. The sensing valve according to claim 18 comprising a graphic user interface configured for displaying a current valve status and said report file, statistic file and an alarm files stored in said memory unit.

27.-47. (canceled)
